(19) United States
(12) Patent Application Publication
(10) Pub. No.: US 2024/0235020 A1
(43) Pub. Date: Jul. 11, 2024

(54) ANTENNA, MANUFACTURING METHOD, DRIVING METHOD, AND ANTENNA SYSTEM

(71) Applicant: BOE TECHNOLOGY GROUP CO., LTD., Beijing (CN)

(72) Inventors: Jia FANG, Beijing (CN); Hai YU, Beijing (CN); Yang ZHENG, Beijing (CN)

(21) Appl. No.: 17/907,091

(22) PCT Filed: Oct. 22, 2021
(86) PCT No.: PCT/CN2021/125804

§ 371 Date: Sep. 22, 2022

(30) Foreign Application Priority Data
Nov. 30, 2020 (CN) 202011380431.7

(51) Int. Cl. H01Q 3/34; H01P 1/18; H01P 3/00; H01Q 3/44; H01Q 21/00; H01Q 21/06

(52) U.S. Cl. CPC H01Q 3/34; H01P 1/184; H01P 3/003; H01Q 3/44; H01Q 21/0087; H01Q 21/064

(57) ABSTRACT

The present disclosure provides an antenna, a manufacturing method, a driving method, and an antenna system. The antenna includes: at least one group of antenna units; each group including a first antenna unit and a second antenna unit; at least one group of phase shift units, each group including a first phase shift unit coupled to the first antenna unit and a second phase shift unit coupled to the second antenna unit; and a power division transmission unit including at least one first power divider. Each first power divider includes a first end coupled to a first phase shift unit, a second end coupled to the second phase shift unit, and a third end, and a phase difference between a microwave signal transmitted from the first end to the third end and a microwave signal transmitted from the second end to the third end is a preset value.

### CROSS REFERENCE OF RELATED APPLICATION

This application claims a priority of the Chinese patent application No. 202011380431.7 filed on Nov. 30, 2020, which is incorporated herein by reference in its entirety.

### TECHNICAL FIELD

The present disclosure relates to the field of antenna technology, in particular to an antenna, a manufacturing method, a driving method, and an antenna system.

### BACKGROUND

Liquid crystal phased array antenna based on an inverted microstrip line structure has such advantages as low profile, low cost and pure electronic scanning. However, since an inverted microstrip line structure is adopted for a phase shifter, a thickness of a liquid crystal layer is highly demanded to some extent, and usually the thickness is not less than 100 μm, resulting in a slow response speed of the phase shifter.

Through introducing a structure in which a transmission line is periodically connected in parallel to a variable capacitor, a capacitance value of the variable capacitor is changed, so as to change a phase. When the variable capacitor is a flat-plate capacitor, liquid crystals serve as a dielectric layer, and a dielectric constant of the dielectric layer is changed through controlling a voltage applied to the liquid crystals, so as to change the capacitance and shift the phase. In this structure, the thickness of the liquid crystal layer is reduced to 3 μm to 8 μm, and the response speed of the phase shifter is increased remarkably. However, when the liquid crystal array antenna includes the liquid crystal phase shifter with this structure, a pitch between the antennae is highly demanded, usually 0.5λ to 0.6λ, where λ is a wavelength of a microwave signal. At this time, the antenna has a relatively large volume.

### SUMMARY

An object of the present disclosure is to provide an antenna, a manufacturing method, a driving method and an antenna system, so as to improve a response speed of the antenna and reduce a volume of the antenna.

In order to solve the above technical problem, the present disclosure provides the following technical solutions.

In a first aspect, the present disclosure provides in some embodiments an antenna, including: at least one group of antenna units; at least one group of phase shift units, each group of phase shift units corresponding to a group of antenna units, each phase shift unit being configured to perform phase adjustment on a microwave signal; and a power division transmission unit. Each group of the antenna units includes a first antenna unit and a second antenna unit, each group of the phase shift units includes a first phase shift unit coupled to the first antenna unit and a second phase shift unit coupled to the second antenna unit, the power division transmission unit includes at least one first power divider, each first power divider includes a first end, a second end and a third end, the first end is coupled to the first phase shift unit, the second end is coupled to the second phase shift unit, and a phase difference between a microwave signal transmitted from the first end to the third end and a microwave signal transmitted from the second end to the third end is a preset value.

In a possible embodiment of the present disclosure, a line between the first end and the third end of each the first power divider is a first line, a line between the second end and the third end of each first power divider is a second line, and a difference between a length of the first line and a length of the second line is an odd multiple of a half wavelength of the microwave signal.

In a possible embodiment of the present disclosure, the antenna further includes a first resistor coupled to both the first line and the second line.

In a possible embodiment of the present disclosure, each antenna unit includes: a first substrate; a first reference electrode arranged at a side of the first substrate and provided with a first via hole; and a radiation patch arranged at a side of the first substrate away from the first reference electrode, an orthogonal projection of the radiation patch onto the first substrate overlapping an orthogonal projection of the first via hole onto the first substrate at a first overlapping region.

In a possible embodiment of the present disclosure, each phase shift unit includes: a second substrate and a third substrate arranged opposite to each other, the second substrate being arranged at a side of the first reference electrode away from the first substrate; a coplanar waveguide transmission line located at a side of the third substrate facing the second substrate; a loading electrode located at a side of the second substrate facing the third substrate; and a liquid crystal layer located between the second substrate and the third substrate. The coplanar waveguide transmission line includes a fourth end coupled to the first power divider and a fifth end coupled to the antenna unit.

In a possible embodiment of the present disclosure, the first overlapping region at least partially overlaps an orthogonal projection of a portion of the coplanar waveguide transmission line close to the fifth end onto the first substrate.

In a possible embodiment of the present disclosure, the first power divider is arranged at a same layer and made of a same material as the coplanar waveguide transmission line.

In a possible embodiment of the present disclosure, a first insulation layer is arranged between the loading electrode and the second substrate, and a second insulation layer is arranged at a side of the loading electrode away from the first insulation layer.

In a possible embodiment of the present disclosure, the coplanar waveguide transmission lines of all the phase shift units are electrically coupled to each other through a same signal line, and the loading electrodes of different phase shift units are insulated from each other.

In a possible embodiment of the present disclosure, the power division transmission unit further includes at least one second power divider, each second power divider includes a sixth end and a plurality of seventh ends, and each seventh end is coupled to the third end of one first power divider.

In a possible embodiment of the present disclosure, the power division transmission unit further includes a second reference electrode arranged at a side of the third substrate away from the coplanar waveguide transmission line.

In a possible embodiment of the present disclosure, the first reference electrode is provided with at least one second via hole, the second reference electrode is provided with at least one third via hole, the second via holes correspond to the third via holes respectively, an orthogonal projection of each second via hole onto the third substrate overlaps an orthogonal projection of one third via hole onto the third substrate at a second overlapping region, and the second overlapping region at least partially overlaps an orthogonal projection of one third end onto the third substrate.

In a possible embodiment of the present disclosure, the power division transmission unit further includes: a fourth substrate arranged between the second power divider and the second reference electrode; a fifth substrate arranged at a side of the second power divider away from the fourth substrate; and a third reference electrode arranged at a side of the fifth substrate away from the second power divider.

In a possible embodiment of the present disclosure, the third reference electrode is provided with at least one fourth via hole, the fourth via holes correspond to the third via holes respectively, an orthogonal projection of each fourth via hole onto the fifth substrate overlapping regions an orthogonal projection of one third via hole onto the fifth substrate at a third overlapping region, and the third overlapping region at least partially overlaps an orthogonal projection of one seventh end onto the fifth substrate.

In a possible embodiment of the present disclosure, the power division transmission unit further includes: a sixth substrate arranged at a side of the third reference electrode away from the fifth substrate; and a back reflection layer arranged at a side of the sixth substrate away from the third reference electrode.

In a possible embodiment of the present disclosure, the power division transmission unit further includes: a support frame arranged at a side of the back reflection layer away from the sixth substrate; and a waveguide arranged at a side of the support frame away from the sixth substrate.

In a possible embodiment of the present disclosure, the waveguide is coupled to the sixth end through a connector.

In a second aspect, the present disclosure provides in some embodiments an antenna system including the above-mentioned antenna.

In a third aspect, the present disclosure provides in some embodiments a method for manufacturing an antenna, including: forming at least one group of antenna units; forming at least one group of phase shift units, each group of phase shift units corresponding to a group of antenna units, each phase shift unit being configured to perform phase adjustment on a microwave signal; and forming a power division transmission unit. Each group of the antenna units includes a first antenna unit and a second antenna unit, each group of the phase shift units includes a first phase shift unit coupled to the first antenna unit and a second phase shift unit coupled to the second antenna unit, the power division transmission unit includes at least one first power divider, each first power divider includes a first end, a second end and a third end, the first end is coupled to the first phase shift unit, the second end is coupled to the second phase shift unit, and a phase difference between a microwave signal transmitted from the first end to the third end and a microwave signal transmitted from the second end to the third end is a preset value.

In a possible embodiment of the present disclosure, the forming the antenna unit includes: providing a first substrate; forming a radiation patch array at a side of the first substrate; and forming a first reference electrode at the other side of the first substrate.

In a possible embodiment of the present disclosure, the forming the phase shift unit includes: providing a second substrate and a third substrate; forming a coplanar waveguide transmission line on the third substrate; forming a loading electrode on the second substrate; aligning the third substrate with the second substrate to form a cell, the coplanar waveguide transmission line and the loading electrode being arranged between the third substrate and the second substrate; and filling a liquid crystal layer between the third substrate and the second substrate.

In a possible embodiment of the present disclosure, the antenna unit is combined with the phase shift unit through bonding.

In a fourth aspect, the present disclosure provides in some embodiments a method for driving the antenna, including: receiving, by each of a first antenna unit and a second antenna unit of each group of antenna units, a microwave signal; performing, by a first phase shift unit, phase adjustment on the microwave signal received by the first antenna unit; performing, by a second phase shift unit, phase adjustment on the microwave signal received by the second antenna unit; and combining, by a first power divider, the microwave signal adjusted by the second phase shift unit and the microwave signal adjusted by the first phase shift unit into one signal; and/or, dividing, by the first power divider, a microwave signal into two signals, and transmitting the signals to the first phase shift unit and the second phase shift unit respectively; performing, by the first phase shift unit, phase adjustment on the microwave signal transmitted to the first phase shift unit, and performing, by the second phase shift unit, phase adjustment on the microwave signal transmitted to the second phase shift unit; and transmitting, by first antenna unit, the microwave signal adjusted by the first phase shift unit, and transmitting, by second antenna unit, the microwave signal adjusted by the second phase shift unit.

### BRIEF DESCRIPTION OF THE DRAWINGS

FIG. 1 is a schematic view of a conventional liquid crystal phased array antenna with an inverted microstrip line structure;

FIG. 2 and FIG. 3 are schematic views of a liquid crystal phase shift unit based on a CPW transmission line;

FIG. 4a-4f are schematic views of an antenna according to one embodiment of the present disclosure;

FIG. 4h-4j are schematic views of a phase shift unit according to one embodiment of the present disclosure;

FIG. 4k is a simulation schematic view showing a change in the performance of the phase shift unit when the phase shift unit is bent at different levels according to one embodiment of the present disclosure;

FIG. 5 is a planar view of the phase shift unit according to one embodiment of the present disclosure; and

FIG. 6 and FIG. 7 are schematic views showing a first power divider according to one embodiment of the present disclosure.

### DETAILED DESCRIPTION

In order to make the objects, the technical solutions and the advantages of the present disclosure more apparent, the present disclosure will be described hereinafter in a clear and complete manner in conjunction with the drawings and embodiments.

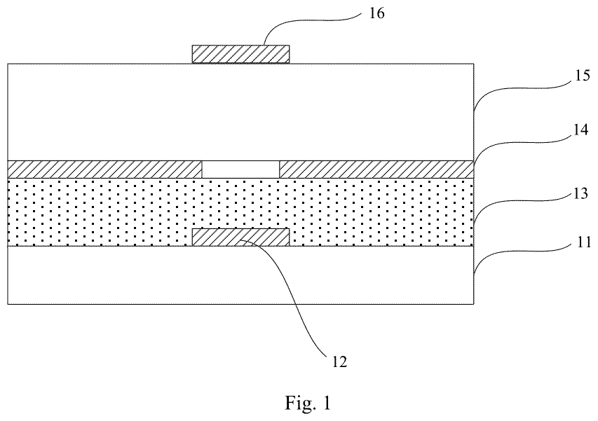

As shown in FIG. 1, a liquid crystal phased array antenna based on an inverted microstrip line structure includes a substrate 11, a substrate 15, a liquid crystal layer 13 located between the substrate 11 and the substrate 15, a feed line 12 located at a side of the substrate 11 facing the liquid crystal layer 13, and a ground electrode 14 located at a side of the substrate 15 facing the liquid crystal layer 13. The liquid crystal phased array antenna has such advantages as low profile, low cost and pure electronic scanning. However, since the inverted microstrip line structure is adopted by a phase shifter thereof, a thickness of the liquid crystal layer is highly demanded to some extents, and usually the thickness of the liquid crystal layer is not less than 100 μm, resulting in a slow response speed of the phase shifter.

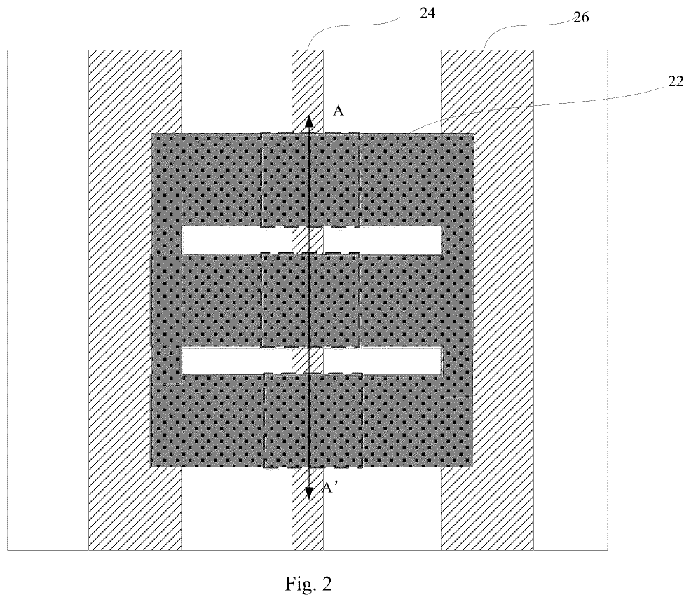

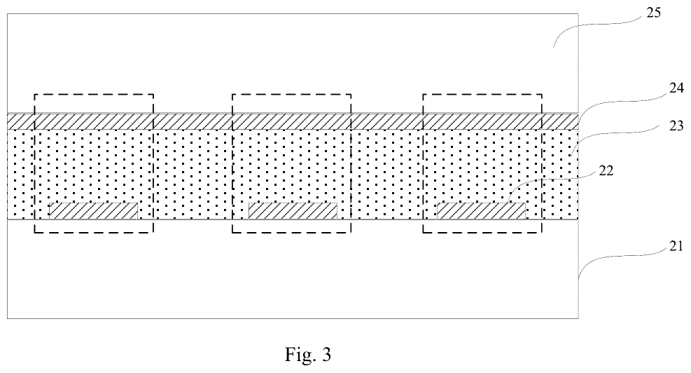

FIG. 2 and FIG. 3 show a liquid crystal phase shift unit based on a coplanar waveguide (CPW) transmission line, and FIG. 3 is a sectional view of the liquid crystal phase shift unit along line AA′ in FIG. 2. The liquid crystal phase shift unit includes a substrate 21, a substrate 25, an electrode 22 located on the substrate 21, a CPW transmission line located on the substrate 25 and including a coplanar waveguide transmission line 24 and two base electrodes 26 located at two sides of the coplanar waveguide transmission line 24 respectively, and a liquid crystal layer 23 located between the substrate 21 and the substrate 25. Through introducing a structure in which the transmission line is periodically connected in parallel to a variable capacitor, a capacitance value of the variable capacitor is changed, so as to change a phase. When the variable capacitor is a flat-plate capacitor, liquid crystals serve as a dielectric layer, and a dielectric constant of the dielectric layer is changed through controlling a voltage applied to the liquid crystals, so as to change the capacitance and shift the phase. g. In this structure, the thickness of the liquid crystal layer is reduced to 3 μm to 8 μm, and the response speed of the phase shifter is increased remarkably. However, when the liquid crystal array antenna includes the liquid crystal phase shifter with this structure, in order to ensure the isolation between adjacent liquid crystal phase shift units, a pitch between the antennae is highly demanded, usually 0.5λ to 0.6λ, where λ is a wavelength of a microwave signal. At this time, an area available for the layout of the liquid crystal phase shift unit for each antenna unit is merely 0.5*0.5λ2. In addition, taking the encapsulation and an antenna coupling region into consideration, the area may be further reduced. Furthermore, for the structure in which the CPW transmission line is periodically connected in parallel to the variable capacitor, the CPW transmission line serves as a transmission structure, and the base electrodes 26 and the coplanar waveguide transmission line 24 are arranged on a same plane, so it is difficult to provide the phase shift unit at a region having the area of 0.5*0.5λ2. In other words, for the liquid crystal phase shift unit where the CPW transmission line is periodically connected in parallel to the variable capacitor, although it has a small cell thickness, the overall layout is very compact due to its large size.

An object of the present disclosure is to provide an antenna, a manufacturing method, a driving method, and an antenna system, so as to improve a response speed of the antenna and reduce a size of the antenna.

The present disclosure provides in some embodiments an antenna, which includes: at least one group of antenna units, each antenna unit being configured to receive a microwave signal from the outside and/or transmit a microwave signal to the outside; at least one group of phase shift units, each group of phase shift units corresponding to a group of antenna units, each phase shift unit being configured to perform phase adjustment on the microwave signal (when each group of phase shift units corresponds to a group of antenna units, it means that the quantity of groups of phase shift units is the same as the quantity of groups of antenna units, the groups of phase shift units correspond to the groups of antenna units respectively, different groups of antenna units correspond to different groups of phase shift units, each group of phase shift units is configured to receive the microwave signal from the corresponding group of antenna units and perform phase adjustment on the microwave signal, and the antenna unit is configured to transmit the microwave signal after the phase adjustment); a power division transmission unit configured to combine multiple phase-adjusted microwave signals outputted by the groups of phase shift units into one microwave signal and output the microwave signal. Each group of the antenna units includes a first antenna unit and a second antenna unit, each group of the phase shift units includes a first phase shift unit coupled to the first antenna unit and a second phase shift unit coupled to the second antenna unit. The above-mentioned “coupling” refers to a coupling connection, i.e. a coupling connection is provided between the first antenna unit and the first phase shift unit, and a coupling connection is provided between the second antenna unit and the second phase shift unit. The power division transmission unit includes at least one first power divider, each first power divider includes a first end, a second end and a third end, the first end is coupled to the first phase shift unit, the second end is coupled to the second phase shift unit, and a phase difference between a microwave signal transmitted from the first end to the third end and a microwave signal transmitted from the second end to the third end is a preset value.

The first end of the first power divider is directly electrically coupled to the first phase shift unit, and the second end of the first power divider is directly electrically coupled to the second phase shift unit.

The preset value may be, but not limited to, 180°, e.g., any other values when the structure of the first power divider is adjusted according to the practical need.

In the embodiments of the present disclosure, the phase shift units receive the microwave signal from the corresponding group of antenna units and perform phase adjustment on the microwave signal. The power division transmission unit includes the first power divider, which is coupled to the first phase shift unit and the second phase shift unit, and configured to combine the microwave signal adjusted by the second phase shift unit by the preset value and the microwave signal outputted by the first phase shift unit into one microwave signal. Through the first power divider, the phase difference between the microwave signal outputted by the first phase shift unit and the microwave signal outputted by the second phase shift unit is the preset value, so as to improve the isolation between the adjacent phase shift units, and achieve the arrangement of the phase shift units within a very small space while satisfying the requirement on antenna mirror feed, thereby to make full use of the space insider the antenna and reduce a volume of the antenna.

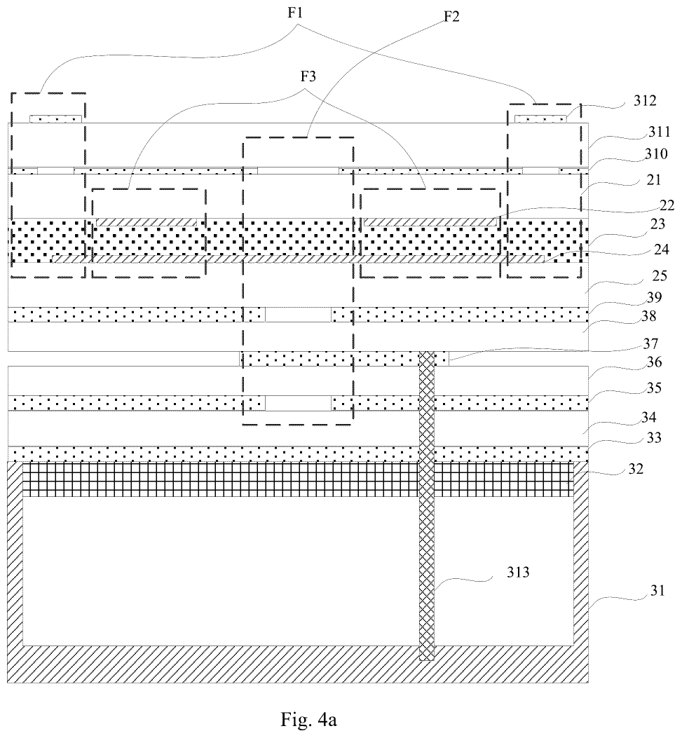

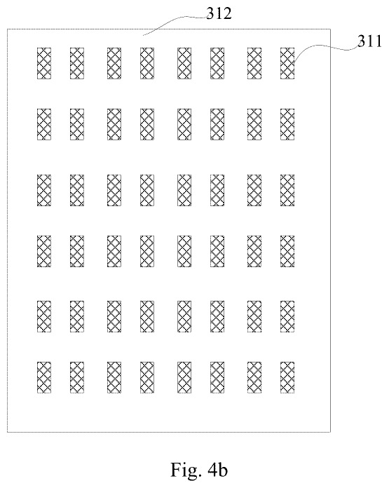

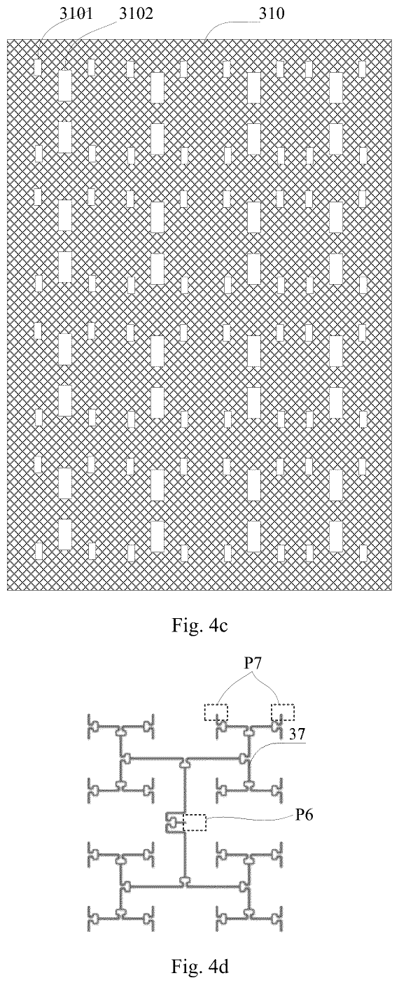

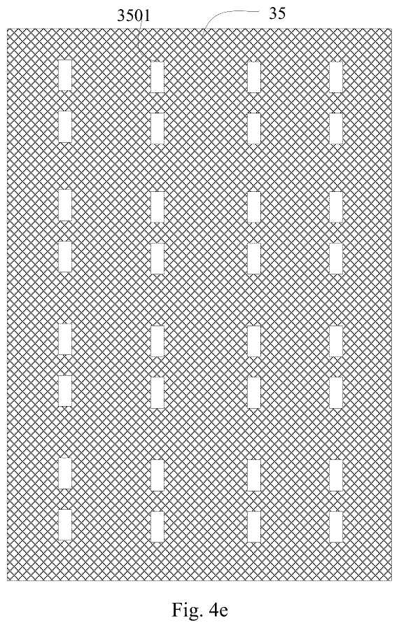

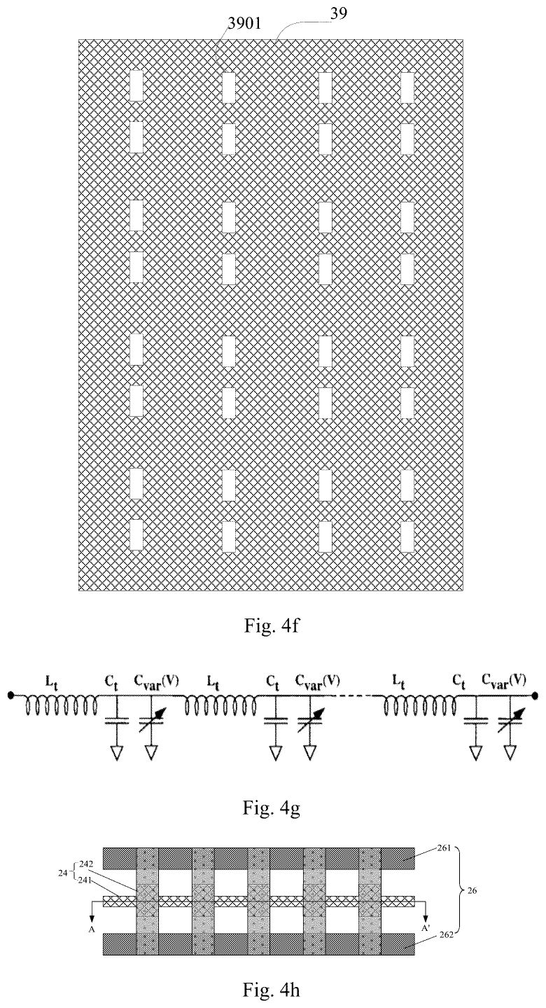

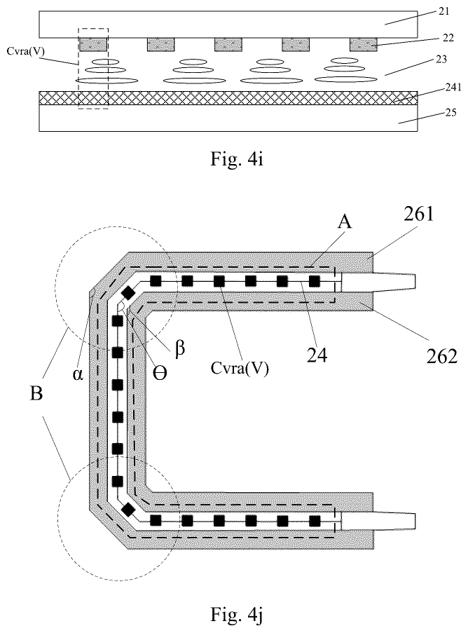

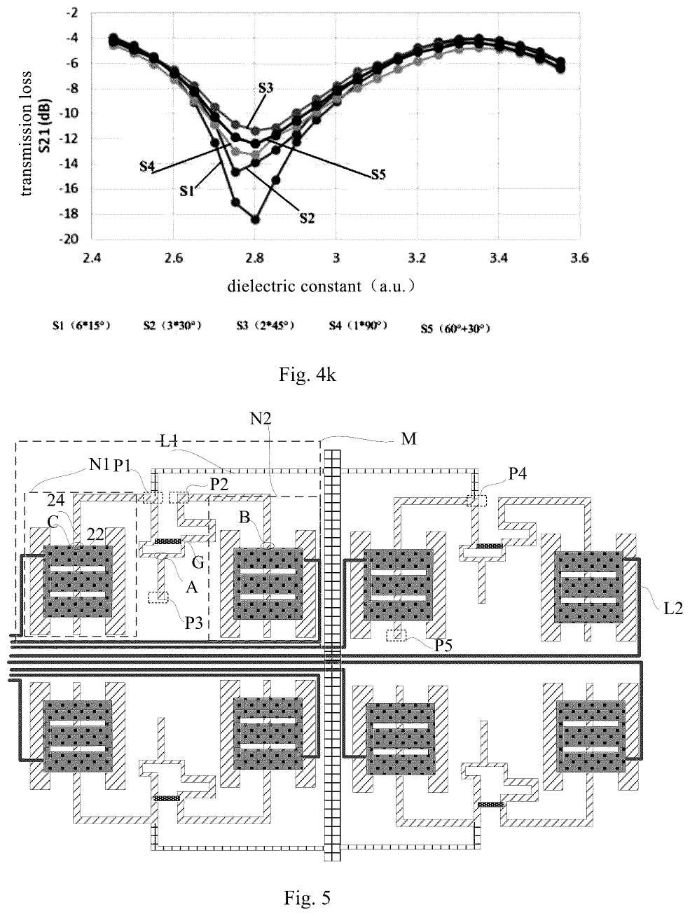

As shown in FIG. 4a which shows an antenna according to one embodiment of the present disclosure, the antenna includes multiple groups of antenna units F1, multiple groups of phase shift units F3 and a power division transmission unit.

As shown in FIG. 4a-4c, the antenna unit F1 includes a first substrate 311, a first reference electrode 310 arranged at a side of the first substrate 311, and a radiation patch 312 arranged at a side of the first substrate 311 away from the first reference electrode 310. As shown in FIG. 4c, the first reference electrode 310 is provided with a first via hole 3101, and the first reference electrode 310 is provided with a via hole 3102. The first reference electrode 310 serves as a ground electrode of the microstrip antenna and a ground electrode of a strip-like transmission line (i.e. a coplanar waveguide transmission line 24). Through the via holes, the energy on the strip-like transmission line is radiated to excite the radiation patch 312. As shown in FIG. 4c, the via holes 3101 and 3102 are each of a rectangular or rounded rectangular shape. Of course, the via holes 3101 and 3102 may also be of any other shapes. The via hole 3101 is used for the energy coupling of the antenna, and the via hole 3102 is used for the radiation of the energy on the strip-like transmission line so as to excite the radiation patch 312. An orthogonal projection of the via hole 3101 onto the first substrate 311 overlaps an orthogonal projection of the radiation patch 312 onto the first substrate 311 at a first overlapping region, and a center of the via hole 3101 coincides with, or does not coincide with, a center of the radiation patch 312.

As shown in FIG. 4b, a plurality of radiation patches 312 is arranged in an array form on the first substrate 311 to receive and/or transmit an external microwave signal. Each radiation patch 312 is of a rectangular or rounded rectangular shape. Of course, the radiation patch 312 may also be of any other shapes. A width of the radiation patch 312 is a half of a wavelength of an operating frequency of the antenna. The longer the length of the radiation patch 312, the larger the antenna gain, and the larger the coupling between the adjacent antenna units, so the radiation patch 312 may be of a square shape. The antenna unit F1 transmits the received microwave signal to the phase shift unit F3, the phase shift unit F3 transmits the phase-shifted microwave signal to a metallic connector 313 through a down-coupling structure F2 of the power division transmission unit, the metallic connector 313 transmits the microwave signal to a waveguide 31, and the waveguide 31 combines the microwave signals into one microwave signal.

Each group of antenna units F1 includes two symmetrical antenna units, i.e., the first antenna unit and the second antenna unit, each group of phase shift units F3 includes two phase shift units, i.e., the first phase shift unit and the second phase shift unit, the phase shift units correspond to the antenna units respectively, the first antenna unit is coupled to the first phase shift unit, and the second antenna unit is coupled to the second phase shift unit. Each phase shift unit receives the microwave signal from the corresponding antenna unit, and the antenna unit F1 transmits the microwave signal to the phase shift unit F3 through mirror feed. The radiation patch 312 transmits the received microwave signal to the coplanar waveguide transmission line 24 through spatial coupling. In this way, it is unnecessary to provide any line between the antenna unit and the phase shift unit to transmit the microwave signal without any process for forming the via holes and the lines, thereby to simplify the structure of the antenna and the manufacture process thereof.

As shown in FIG. 4a and FIG. 5, the antenna includes multiple groups of phase shift units M arranged in an array form, and each group of phase shift units M includes two phase shift units N1 and N2. As shown in FIG. 2 to FIG. 5, each phase shift unit includes: a second substrate 21 and a third substrate 25 arranged opposite to each other, the second substrate 21 being arranged at a side of the first reference electrode 310 away from the first substrate 311; the coplanar waveguide transmission line 24 located at a side of the third substrate 25 facing the second substrate 21; a loading electrode 22 located at a side of the second substrate 21 facing the third substrate 25; and a liquid crystal layer 23 located between the second substrate 21 and the third substrate 25. The coplanar waveguide transmission line 24 includes a fourth end P4 coupled to the first power divider and a fifth end P5 coupled to the antenna unit.

In the phase shift unit in the embodiments of the present disclosure, the coplanar waveguide transmission line 24 is periodically connected in parallel to a variable capacitance, and a phase is changed through changing a capacitance of the variable capacitor. FIG. 4g shows an equivalent model, where Lt and Ct are an equivalent line inductance and an equivalent line capacitance of the coplanar waveguide transmission line 24, which depend on the characteristics of the coplanar waveguide transmission line 24 and the substrate. The variable capacitance Cvar (V) is realized through an MEMS capacitor, a variable diode capacitor, or the like. At present, a capacitance of a plate capacitor is changed through voltage-controlled liquid crystals, so as to obtain a liquid crystal phase shift unit.

When the liquid crystal array antenna is prepared using the phase shift unit in which the CPW is periodically connected in parallel to the variable capacitor, a pitch between the array antennae is highly demanded, usually 0.5λ-0.6λ. In order to meet this requirement, an area for the layout of the liquid crystal phase shift unit of each antenna unit is only 0.5*0.5λ2. At the same time, the phase shift unit needs to provide a phase shift angle of 360°, so the coplanar waveguide transmission line needs to be bent. However, when the coplanar waveguide transmission line is bent in different ways, the phase-shifting performance of the phase shift unit may be adversely affected to some extents.

In order to solve the above-mentioned problems, the present disclosure provides the following technical solutions. At first, it should be appreciated that, a dielectric layer in the phase shift unit mentioned hereinafter includes, but not limited to, a liquid crystal layer 23. The following description will be given when the dielectric layer is the liquid crystal layer 23.

As shown in FIGS. 4h to 4j, the present disclosure provides in some embodiments a phase shift unit, which includes a first substrate, a second substrate arranged opposite to the first substrate, and a liquid crystal layer 23 arranged between the first substrate and the second substrate. FIG. 4i is a sectional view of the phase shift unit along line AA′ in FIG. 4h.

The first substrate includes a third substrate 25, and a base electrode 26 and a coplanar waveguide transmission line 24 arranged at a side of the third substrate 25 close to the liquid crystal layer 23. The coplanar waveguide transmission line 24 includes a body structure 241 and a plurality of branch structures 242 each couple to the body structure in a length direction of the body structure.

The second substrate includes a second substrate 21, and a plurality of loading electrodes 22 arranged at a side of the second substrate 21 close to the liquid crystal layer 23 and corresponding to the plurality of branch structures 242 respectively to form a plurality of variable capacitors Cvra (V). An orthogonal projection of each loading electrode 22 onto the third substrate 25 at least partially overlaps an orthogonal projection of the base electrode 26 onto the third substrate 25.

As shown in FIG. 4j, the plurality of variable capacitors Cvra (V) is linearly arranged to define a variable capacitance region A. The variable capacitance region A has at least one corner sub-region B, the coplanar waveguide transmission line 24 has a plurality of bending angles θ at the corner sub-region B, and a sum of values of the bending angles is 90°. Through bending the signal electrode by 90°, it is able to reduce an area occupied by the phase shift unit in the phased array antenna, and through providing the coplanar waveguide transmission line 24 with the plurality of bending angles θ at the corner sub-region B, it is able to improve the phase shifting performance of the phase shift unit.

The coplanar waveguide transmission line 24 of the phase shift unit is of a U-shaped, annular or S-shaped structure. In the case of a U-shaped structure, there are two corner sub-regions B; in the case of an annular structure, there are four corner sub-regions B; and in the case of an S-shaped structure, there is a plurality of corner sub-regions B. In the embodiments of the present disclosure, the description will be given when the coplanar waveguide transmission line 24 has a U-shaped structure.

In some embodiments of the present disclosure, the coplanar waveguide transmission line 24 has a plurality of bending angles θ at the corner sub-region B. The values of the plurality of bending angles θ are equal, and a sum of the values of the plurality of bending angles θ is 90°. For example, when there are six bending angles, each bending angle θ is 15° (6*15°); when there are three bending angles, each bending angle θ is 30° (3*30°); and when there are two bending angles θ, each bending angle θ is 45° (2*45°).

FIG. 4k is a simulation schematic view showing a change in the performance of the phase shift unit when the phase shift unit is bent at different levels, where S1 represents a curve of the phase shift unit in which the signal line has six 15° bending angles, S2 represents a curve of the phase shift unit in which the signal line has three 30° bending angles, S3 represents a curve of the phase shift unit in which the signal line has two 45° bending angles, S4 represents a curve of the phase shift unit in which the signal line has one 90° bending angle, and S5 represents a curve of the phase shift unit in which the signal line has a 60° bending angle and a 30° bending angle. As shown in FIG. 4k, when a dielectric constant is 2.8, a transmission loss corresponding to the curve S3 (having two 45° bending angles θ) is minimum, and a fluctuation level of the curve S3 is minimum. Hence, when the signal line has two 45° bending angles, the performance of the phase shift unit is optimal.

In some embodiments of the present disclosure, as shown in FIGS. 4h to 4j, the base electrode 26 includes a first base sub-electrode 261 and a second base sub-electrode 262 located at two opposite sides in the length direction of the body structure 241 and corresponding to the branch structures 242. Bending angles (α, β) of the first base sub-electrode 261 and the second base sub-electrode 262 correspond to the bending angle θ of the coplanar waveguide transmission line 24.

In some embodiments of the present disclosure, based on the above, the branch structure 242 penetrates through the body structure 241 so as to transmit the microwave signal stably. In some embodiments of the present disclosure, the branch structures 242 and the body structure 241 are formed integrally, and the branch structures 242 are arranged at a same layer, and made of a same material, as the body structure 241. In this way, it is able to facilitate the manufacture of the branch structures 242 and the body structures 241, and reduce the manufacture cost. Of course, the branch structures 242 may also be electrically coupled to the body structure 241, which will not be particularly defined herein. At this time, when the microwave signal is inputted to the body structure 241, the dielectric constant of the liquid crystal layer 23 in a liquid crystal capacitor formed when the loading electrode 22 overlaps the coplanar waveguide transmission line 24 is changed due to a voltage difference between the loading electrode 22 and the branch structure 242, it is able to change the phase of the microwave signal.

In some embodiments of the present disclosure, spacing distance between any two adjacent variable capacitors Cvra (V) is the same. At this time, a distance between the adjacent loading electrodes 22 is the same, and a distance between the branch structures 242 is also the same. Of course, the distances between the variable capacitors Cvra (V) (the loading electrodes 22, or the branch structures 242) may increase or decrease monotonically according to a certain rule, or may be different from each other without any given rule, which will not be particularly defined herein.

In some embodiments of the present disclosure, the third substrate 25 and the second substrate 21 are each a glass substrate having a thickness of 100 microns to 1000 microns, a sapphire substrate, or a substrate made of polyethylene terephthalate, triallyl cyanate or polyimide and having a thickness of 10 microns to t00 microns. Specifically, the third substrate 25 and the second substrate 21 may each be a high-purity quartz glass substrate having an extremely low dielectric loss. As compared with a common glass substrate, when the third substrate 25 and the second substrate 21 are each a quartz glass substrate, it is able to reduce a microwave loss, thereby to reduce the power consumption of the phase shift unit and increase a signal-to-noise ratio of the phase shift unit.

In some embodiments of the present disclosure, the loading electrode 22, the branch structure 242, the body structure 241 and the base electrode 26 may each be made of a metal such as aluminum, silver, gold, chromium, molybdenum, nickel or iron.

In some embodiments of the present disclosure, liquid crystal molecules in the liquid crystal layer 23 are positive liquid crystal molecules or negative liquid crystal molecules. It should be appreciated that, when the liquid crystal molecules are positive liquid crystal molecules, an angle between a long axis direction of the liquid crystal molecule and a second electrode is greater than 0 degree and less than or equal to 45 degrees. When the liquid crystal molecules are negative liquid crystal molecules, the angle between the long axis direction of the liquid crystal molecules and the second electrode is greater than 45 degrees and less than 90 degrees. In this way, it is able to change the dielectric constant of the liquid crystal layer 23 after the liquid crystal molecules have been deflected, thereby to shift the phase.

In some embodiments of the present disclosure, the first overlapping region at least partially overlaps an orthogonal projection of a portion of the coplanar waveguide transmission line 24 close to the fifth end P5 onto the first substrate 311.

The liquid crystals in the liquid crystal layer 23 is deflected under the effect of a voltage applied to the coplanar waveguide transmission line 24 and the loading electrode 22, so as to change the dielectric constant of the liquid crystal layer, thereby to shift the phase of the microwave signal. In the embodiments of the present disclosure, a thickness of the liquid crystal layer 23 is 3 μm to 8 μm, so as to improve the response speed of the phase shift unit.

The coplanar waveguide transmission line 24 is used for transmitting the microwave signal. In some embodiments of the present disclosure, for the first phase shift unit N1, the coplanar waveguide transmission line 24 outputs a microwave signal at the fourth end P4.

As shown in FIG. 5, a line between the first end P1 and the third end P3 of each first power divider is a first line, a line between the second end P2 and the third end P3 of each first power divider is a second line, and a difference between a length of the first line and a length of the second line is an odd multiple of a half of a wavelength of the microwave signal, so that the microwave signal outputted by the second phase shift unit is phase-shifted by 180° and then combined with the microwave signal outputted by the first phase shift unit to be outputted as one microwave signal. In the embodiments of the present disclosure, through the first power divider, a difference between a phase of the microwave signal outputted by the first phase shift unit and a phase of the microwave signal outputted by the second phase shift unit is 180°, so as to improve the isolation between the adjacent phase shift units. In this way, it is unnecessary to provide a large distance between the adjacent phase shift units, and provide the phase shift unit within a very small space while meeting the requirement on antenna mirror feed, thereby to make full use of the internal space of the antenna and reduce the volume of the antenna.

In some embodiments of the present disclosure, the first power divider is arranged at a same layer, and made of a same material, as the coplanar waveguide transmission line 24. In this way, the first power divider and the coplanar waveguide transmission line 24 are simultaneously formed through a single patterning process, so it is able to simplify the manufacture of the antenna, reduce the tact time of the antenna, and reduce the manufacture cost of the antenna.

In some embodiments of the present disclosure, a first insulation layer is arranged between the loading electrode 22 and the second substrate 21, and a second insulation layer is arranged at a side of the loading electrode 22 away from the first insulation layer. The first insulation layer is made of silicon nitride or silicon oxide, and it has a thickness of about 150 nm, so as to reduce a stress generated during the manufacture of the loading electrode 22, thereby to avoid the second substrate 21 from being broken due to stress concentration. The second insulation layer is made of silicon nitride or silicon oxide, and it has a thickness of about 50 nm, so as to protect the loading electrode 22.

In order to further improve the isolation between the adjacent phase shift units, as shown in FIG. 5, the antenna further incudes a first resistor G coupled to both the first line and the second line. The first resistor is made of a high-resistance thin film material, e.g., at least one of ITO, ZnO:Al and ZnO:B through magnetron sputtering, thermal evaporation or electroplating. The first resistor is arranged at a same layer as the first power divider.

Due to the introduction of the power division transmission unit, the coplanar waveguide transmission lines 24 of adjacent phase shift units are coupled to each other to be maintained at a same potential. In order to provide different phase shift units with different phase shifting capabilities, in the embodiments of the present disclosure, a voltage is applied reversely. As shown in FIG. 5, the coplanar waveguide transmission lines 24 of all the phase shifting units are coupled to each other through a line L1, i.e., the coplanar waveguide transmission lines of all the phase shift units are electrically coupled to each other through a same signal line. At this time, a same voltage, for example 0.1V, is applied to all the coplanar waveguide transmission lines 24. However, the loading electrodes 22 of different phase shift units are independent of each other and insulated from each other, and each phase shift unit is independently powered through a line L2. In this way, it is able to prevent the transmission of a radio frequency signal from being adversely affected when the CPW transmission line, in the case of being grounded, is at a same potential as an actual ground electrode.

In the embodiments of the present disclosure, as shown in FIG. 4d, the power division transmission unit further includes at least one second power divider 37. Each second power divider 37 includes a sixth end P6 and a plurality of seventh ends P7, each seventh end P7 is coupled to the third end P3 of one of the first power dividers. The second power divider is configured to combine the microwave signals outputted by M first power dividers into N microwave signals, and output the N microwave signals to the waveguide, where M is an integer greater than 1, and N is less than M. The above-mentioned connection is coupling connection.

With the development of the radio frequency technology and the microwave technology, miniaturization becomes an important trend, so it is necessary to improve an integration level of a microwave circuitry as possible. As key to solve this problem, a microwave multi-layer board technology is used to provide a miniaturized, low-cost and high-performance microwave circuitry. However, at this time the layout of lines of the microwave circuitry is more complex, and the microwave signal needs to be transmitted between different transmission lines. The signals transmitted through the transmission lines at different layers are isolated from each other through metal.

Furthermore, when a signal is transmitted between the transmission lines at different layers, a suitable transition structure needs to be introduced, so as to avoid the occurrence of the signal reflection and the excitation of higher order modes, thereby to transmit the signal to the transmission line at another layer at a minimum loss. Hence, it is very critical to study the transition structure between the transmission lines.

Generally, there are two modes of transition structures between the transmission lines. In a first mode, a via hole is formed in the substrate and then metallized to achieve the transmission of the signal. In this mode, the transmission lines at different layers are physically coupled to each other, and a small transmission loss is provided through size optimization, but the manufacture process is highly demanded. In a second mode, energy is transferred between the transmission lines at different layers through microwave spatial coupling. At this time, the manufacture process is less demanded, but a large transmission loss usually occurs due to the coupling between the transmission lines at different layers.

For microwave elements with a glass substrate, such as a phase shift unit, an antenna or a filter, the metallic via hole is not suitable for the energy transfer between the transmission lines at different layers because a drilling technique in the glass substrate is immature and the glass substrate is fragile.

In order to solve the above-mentioned problems, as shown in FIG. 4a, the power division transmission unit includes a first Printed Circuit Board (PCB), a second PCB and a third PCB laminated one on another. The first PCB includes a sixth substrate 34, the second PCB includes a fifth substrate 36, and the third PCB includes a fourth substrate 38. A back reflection layer 33 and a third reference electrode 35 are arranged at two sides of the sixth substrate 34 respectively, the second power divider 37 and the third reference electrode 35 are arranged at two sides of the fifth substrate 36 respectively, the second power divider 37 and a second reference electrode 39 are arranged at two sides of the fourth substrate 38 respectively, and the second reference electrode 39 is arranged at a side of the third substrate 25 away from the coplanar waveguide transmission line 24. The second power divider is configured to combine M microwave signals outputted by the first power divider into N microwave signals.

As shown in FIG. 4a, in some embodiments of the present disclosure, the power division transmission unit further includes: a support frame 32 arranged at a side of the back reflection layer 33 away from the sixth substrate 34; and a waveguide 31 arranged at a side of the support frame 32 away from the sixth substrate 34. The waveguide 31 is coupled to the sixth ends P6 of the N second power dividers, and configured to combine N microwave signals into one microwave signal and output the microwave signal, where N is a positive integer.

For example, a thickness of each electrode is, but not limited to, 0.1 μm to 100 μm. In general, the thickness of each electrode is 18 μm or 35 μm. In the embodiments of the present disclosure, when the thickness of each electrode is designed to be greater than or equal to 0.1 μm, it is able to, on one hand, reduce the manufacture difficulty and the manufacture cost, and on the other hand, improve the shielding performance of each electrode. When the thickness of each electrode is designed to be less than or equal to 100 μm, it is able to prevent the power division transmission unit from being too thick due to a large thickness of the electrode, i.e., provide a thin, light and miniaturized power division transmission unit, thereby to enlarge an application range of the power division transmission unit. However, the thickness of each electrode is not limited thereto, and it may be any other values according to the practical need.

A thickness of each substrate is 0.1 mm to 10 mm. In the embodiments of the present disclosure, when the thickness of each substrate is designed to be greater than or equal to 0.1 mm, it is able to, on one hand, reduce the manufacture difficulty and the manufacture cost, and on the other hand, ensure the support strength of each substrate. When the thickness of each substrate is designed to be less than or equal to 10 mm, it is able to prevent the power division transmission unit from being too thick due to a large thickness of the electrode, i.e., provide a thin, light and miniaturized power division transmission unit, thereby to enlarge an application range of the power division transmission unit. However, the thickness of each electrode is not limited thereto, and it may be any other values according to the practical need.

The first reference electrode 310, the second reference electrode 39 and the third reference electrode 35 serve as a shielding structure, the third reference electrode 35 is configured to shield an interference signal below the third reference electrode 35, and the second reference electrode 39 is configured to shield an interference signal above the second reference electrode 39.

To achieve signal coupling, a groove needs to be formed in each of the first reference electrode 310, the second reference electrode 39, and the third reference electrode 35, and the groove penetrates through the electrode in a thickness direction to form a via-hole.

FIG. 4f is a planar view of the second reference electrode 39 provided with at least one third via hole 3901 (commonly referred to as a coupling slot). As shown in FIG. 4c, the first reference electrode 310 is provided with at least one second via hole 3102 (generally referred to as a coupling slot), and the second via holes 3102 correspond to the third via holes 3901 respectively.

An orthogonal projection of each second via hole 3102 onto the third substrate 25 overlaps an orthogonal projection of one of the third via holes 3901 onto the third substrate 25 at a second overlapping region, and the second overlapping region at least partially overlaps an orthogonal projection of one of the third ends P3 onto the third substrate 25.

FIG. 4e is a planar view of the third reference electrode 35 provided with at least one fourth via hole 3501 (generally referred to as a coupling slot), and the fourth via holes 3501 correspond to the third via holes 3901 respectively. An orthogonal projection of each of the fourth via holes 3501 onto the fifth substrate 36 overlaps an orthogonal projection of one of the third via holes 3901 onto the fifth substrate 36 at a third overlapping region, and the third overlapping region at least partially overlaps an orthogonal projection of the seventh end P7 onto the fifth substrate 36. In this way, it is able to achieve the energy radiation and coupling from the third end P3 of the first power divider to the seventh end P7 of the second power divider 37.

It should be appreciated that, in order to improve the coupling efficiency between the first power divider and the second power divider, the third end P3 of the first power divider and the seventh end P7 of the second power divider should be interrupted, i.e., each of them is not coupled to the other conductive structure at a same layer, so as to reduce the energy transfer at the same layer, thereby to enable more energy to be radiated and coupled to the transmission structures at different layers through the third reference electrode 35 and the second reference electrode 39.

In order to achieve a better coupling effect, the third reference electrode 35 and the second reference electrode 39 are symmetrical, and the via hole in the third reference electrode 35 has a same size, and is located at a same position, as the via-hole in the second reference electrode 39. When the via-holes are located at the same position, it means that an orthogonal projection of the via hole 3501 in the third reference electrode 35 onto the fifth substrate 36 coincides with an orthogonal projection of the via hole 3901 in the second reference electrode 39 onto the fifth substrate 36. An orthogonal projection of the second power divider 37 onto the fifth substrate 36 may pass through a center of the orthogonal projection of the via hole 3501 in the third reference electrode 35 onto the fifth substrate 36, so as to enable each of the first power divider and the second power divider to radiate the energy substantially the same to both sides, and reduce the manufacture cost. In other words, the via holes are formed in the third reference electrode 35 and the second reference electrode 39 through a same mask.

The via holes in the first reference electrode 310, the second reference electrode 39 and the third reference electrode 35 are each of a circular or rectangular shape, so as to facilitate the formation. However, the via hole may also be of any other shape according to the practical need. It should be appreciated that, in the embodiments of the present disclosure, a size of the via hole in each of the first reference electrode 310, the second reference electrode 39 and the third reference electrode 35 will not be particularly defined herein, and it may be set according to an operating frequency of the power division transmission unit, the thickness of each substrate and the dielectric constant.

In a possible embodiment of the present disclosure, in the embodiments of the present disclosure, a width of the third end P3 of the first power divider is the same as a width of the via hole in the second reference electrode 39, and a width of the seventh end P7 of the second power divider is the same as a width of the via hole in the third reference electrode 35. It should be appreciated that, the width herein refers to a size in a first direction X.

In some embodiments of the present disclosure, an orthogonal projection of the third end P3 of the first power divider onto the fifth substrate 36 coincides with an orthogonal projection of the via hole in the second reference electrode 39 onto the fifth substrate 36 in the first direction X, i.e., the orthogonal projection of the third end P3 of the first power divider onto the fifth substrate 36 is a first orthogonal projection, the orthogonal projection of the via hole in the second reference electrode 39 onto the fifth substrate 36 is a second orthogonal projection, and two opposite edges of the first orthogonal projection in the first direction X coincide with two opposite edges of the second orthogonal projection in the first direction X respectively. An orthogonal projection of the seventh end P7 of the second power divider onto the fifth substrate 36 coincides with an orthogonal projection of the via hole in the second reference electrode 39 onto the fifth substrate 36 in the first direction X, i.e., the orthogonal projection of the seventh end P7 of the second power divider onto the fifth substrate 36 is a third orthogonal projection, the orthogonal projection of the via hole in the second reference electrode 39 onto the fifth substrate 36 is the second orthogonal projection, and two opposite edges of the third orthogonal projection in the first direction X coincide with two opposite edges of the second orthogonal projection in the first direction X respectively. In this way, it is able to provide a sufficiently large coupling area between the first power divider and the second power divider 37, thereby to improve the coupling efficiency and reduce the transmission loss.

The phase-shifted microwave signal is transmitted to the second power divider 37 through the first power divider. The sixth end P6 of the second power divider 37 is coupled to the waveguide 31 through the metallic connector 313, so as to transmit N microwave signals to the waveguide 31. When the microwave signals are transmitted through the metal connector 313, it is able to reduce the transmission loss of the microwave signals. The waveguide 31 is an aluminum waveguide, and the metallic support frame 32 is provided between the waveguide 31 and the second power divider 37 so as to maintain a certain distance between the waveguide 31 and the second power divider. The waveguide 31 needs to be coupled to the second power divider through the connector, so a certain distance needs to be maintained between the waveguide 31 and the second power divider for the connector. The back reflection layer 33 is formed integrally with the metallic support frame 32.

In the embodiments of the present disclosure, in order to reduce losses of the voltage signals and the microwave signals, the CPW transmission line, the lines and the electrodes may be made of at least one of the following low-resistance and low-loss metals: copper, gold and silver through magnetron sputtering, thermal evaporation and electroplating.

The substrates of the antenna units, the phase shift units and/or the power division transmission units may be an insulation substrate such as a polytetrafluoroethylene fiberglass laminated substrate, a phenolic paper laminated substrate or a phenolic glass cloth laminated substrate, or a rigid substrate having a low microwave loss such as a quartz substrate or a glass substrate. Each substrate has a thickness of 100 μm to 10 mm.

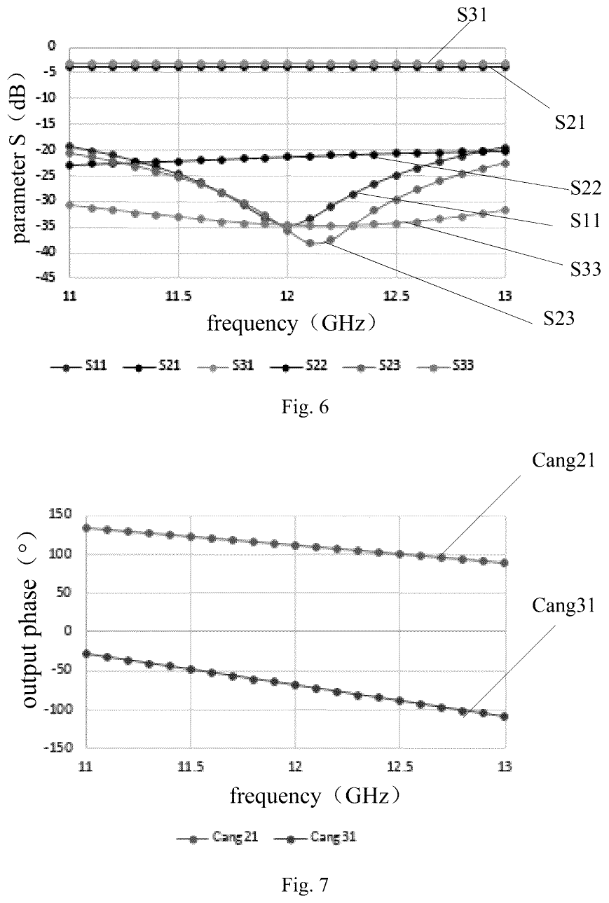

FIG. 6 and FIG. 7 show the performance of the first power divider. The first power divider includes one input port (1) and two output ports (2, 3). S11, S22 and S33 respectively represent a reflection-to-input ratio of the three ports. The smaller the value of the ratio, the smaller the reflection, i.e., the more energy absorbed by the line. S21 and S31 respectively represent energy losses from the port 1 to the port 2 and from the port 1 to the port 3, and if there is no energy loss, the value is 0 dB. The smaller the value, the larger the energy loss. S32 represents an isolation level between the port 2 and the port 3, i.e., a crosstalk of the energy between the two ports. The smaller the value, the smaller the crosstalk. Cang21 represents a difference between a phase at the port 2 and a phase at the port 1 after the energy is fed at the port 1, and Cang31 represents a difference between a phase at the port 3 and the phase at the port 1 after the energy is fed at the port 1. In the embodiments of the present disclosure, the power divider with an output phase difference of 180°, so a difference between Cang21 and Cang31 is desired to be 180°.

The present disclosure further provides in some embodiments a method for driving the above-mentioned antenna, which includes: receiving, by each of a first antenna unit and a second antenna unit of each group of antenna units, a microwave signal; performing, by a first phase shift unit, phase adjustment on the microwave signal received by the first antenna unit; performing, by a second phase shift unit, phase adjustment on the microwave signal received by the second antenna unit; and combining, by a first power divider, the microwave signal adjusted by the second phase shift unit and the microwave signal adjusted by the first phase shift unit into one signal; and/or, dividing, by the first power divider, a microwave signal into two signals, and transmitting the signals to the first phase shift unit and the second phase shift unit respectively; performing, by the first phase shift unit, phase adjustment on the microwave signal transmitted to the first phase shift unit, and performing, by the second phase shift unit, phase adjustment on the microwave signal transmitted to the second phase shift unit; and transmitting, by first antenna unit, the microwave signal adjusted by the first phase shift unit, and transmitting, by second antenna unit, the microwave signal adjusted by the second phase shift unit.

In the embodiments of the present disclosure, when the antenna receives a signal, the radiation patch 312 of the antenna unit transmits the received microwave signal to the coplanar waveguide transmission line 24 of the phase shift unit through spatial coupling, and the coplanar waveguide transmission line 24 transmits the microwave signal. Through applying voltages to the coplanar waveguide transmission line 24 and the loading electrode 22, the liquid crystals in the liquid crystal layer 23 are deflected to change its dielectric constant, so as to shift the phase of the microwave signal.

As shown in FIG. 5, a line between the first end P1 and the third end P3 of each of the first power dividers is a first line, a line between the second end P2 and the third end P3 of each of the first power dividers is a second line, and a difference between a length of the first line and a length of the second line is an odd multiple of a half of a wavelength of the microwave signal, so that the microwave signal outputted by the second phase shift unit is phase-shifted by 180° and then combined with the microwave signal outputted by the first phase shift unit to be outputted as one microwave signal.

Due to the introduction of the power division transmission unit, the coplanar waveguide transmission lines 24 of adjacent phase shift units are coupled to each other to be maintained at a same potential. In order to provide different phase shift units with different phase shifting capabilities, in the embodiments of the present disclosure, a voltage is applied reversely. As shown in FIG. 5, the coplanar waveguide transmission lines 24 of all the phase shifting units are coupled to each other through a line L1, i.e., the coplanar waveguide transmission lines of all the phase shift units are electrically coupled to each other through a same signal line. At this time, a same voltage, for example 0.1V, is applied to all the coplanar waveguide transmission lines 24. However, the loading electrodes 22 of different phase shift units are independent of each other and insulated from each other, and each phase shift unit is independently powered through a line L2. In this way, it is able to prevent the transmission of a radio frequency signal from being adversely affected when the CPW transmission line, in the case of being grounded, is at a same potential as an actual ground electrode.

In the embodiments of the present disclosure, through the first power divider, a difference between a phase of the microwave signal outputted by the first phase shift unit and a phase of the microwave signal outputted by the second phase shift unit is 180°, so as to improve the isolation between the adjacent phase shift units. In this way, it is unnecessary to provide a large distance between the adjacent phase shift units, and provide the phase shift unit within a very small space while meeting the requirement on antenna mirror feed, thereby to make full use of the internal space of the antenna. In addition, after the antenna coupling structure, the liquid crystal phase shift unit and the power division transmission unit are arranged within a very small space, the voltage is applied reversely, a constant voltage is applied to the CPW transmission lines, and a variable voltage is applied to the electrode of each phase shift unit, so as to achieve the control through the voltage. Based on the antenna structure and the voltage control scheme, it is able to facilitate the layout of the antenna with the CPW transmission line or the other transmission line as well as the piezoelectric control.

In addition, in the embodiments of the present disclosure, when the signal is transmitted by the antenna, the first power divider divides the microwave signal into two microwave signals and transmits them to the first phase shift unit and the second phase shift unit respectively. A phase of the received microwave signal is adjusted by the first phase unit, and a phase of the microwave signal is adjusted by the second phase shift unit. Then, the adjusted microwave signal is transmitted by the first antenna unit, and the adjusted microwave signal is transmitted by the second antenna unit. As shown in FIG. 5, a line between the first end P1 and the third end P3 of each first power divider is a first line, a line between the second end P2 and the third end P3 of each first power divider is a second line, and a difference between a length of the first line and a length of the second line is an odd multiple of a half of a wavelength of the microwave signal, so that one of the microwave signals is phase-shifted by 180° and then transmitted to the second phase shift unit.

Due to the introduction of the power division transmission unit, the coplanar waveguide transmission lines 24 of adjacent phase shift units are coupled to each other to be maintained at a same potential. In order to provide different phase shift units with different phase shifting capabilities, in the embodiments of the present disclosure, a voltage is applied reversely. As shown in FIG. 5, the coplanar waveguide transmission lines 24 of all the phase shifting units are coupled to each other through a line L1, i.e., the coplanar waveguide transmission lines of all the phase shift units are electrically coupled to each other through a same signal line. At this time, a same voltage, for example 0.1V, is applied to all the coplanar waveguide transmission lines 24. However, the loading electrodes 22 of different phase shift units are independent of each other and insulated from each other, and each phase shift unit is independently powered through a line L2. In this way, it is able to prevent the transmission of a radio frequency signal from being adversely affected when the CPW transmission line, in the case of being grounded, is at a same potential as an actual ground electrode.

In the embodiments of the present disclosure, through the first power divider, a difference between a phase of the microwave signal outputted by the first phase shift unit and a phase of the microwave signal outputted by the second phase shift unit is 180°, so as to improve the isolation between the adjacent phase shift units. In this way, it is unnecessary to provide a large distance between the adjacent phase shift units, and provide the phase shift unit within a very small space while meeting the requirement on antenna mirror feed, thereby to make full use of the internal space of the antenna. In addition, after the antenna coupling structure, the liquid crystal phase shift unit and the power division transmission unit are arranged within a very small space, the voltage is applied reversely, a constant voltage is applied to the CPW transmission lines, and a variable voltage is applied to the electrode of each phase shift unit, so as to achieve the control through the voltage. Based on the antenna structure and the voltage control scheme, it is able to facilitate the layout of the antenna with the CPW transmission line or the other transmission line as well as the piezoelectric control.

The present disclosure further provides in some embodiments an antenna system including the above-mentioned antenna. The antenna system may be applied to a communication device.

The present disclosure further provides in some embodiments a method for manufacturing an antenna, which includes: forming at least one group of antenna units; forming at least one group of phase shift units, each group of phase shift units corresponding to a group of antenna units, each phase shift unit being configured to perform phase adjustment on a microwave signal; and forming a power division transmission unit. Each group of the antenna units includes a first antenna unit and a second antenna unit, each group of the phase shift units includes a first phase shift unit coupled to the first antenna unit and a second phase shift unit coupled to the second antenna unit, the power division transmission unit includes at least one first power divider, each first power divider includes a first end, a second end and a third end, the first end is coupled to the first phase shift unit, the second end is coupled to the second phase shift unit, and a phase difference between a microwave signal transmitted from the first end to the third end and a microwave signal transmitted from the second end to the third end is a preset value.

In the embodiments of the present disclosure, the phase shift units receive the microwave signal from the corresponding group of antenna units and perform phase adjustment on the microwave signal. The power division transmission unit includes the first power divider, which is coupled to the first phase shift unit and the second phase shift unit, and configured to combine the microwave signal adjusted by the second phase shift unit by the preset value and the microwave signal outputted by the first phase shift unit into one microwave signal. Through the first power divider, the phase difference between the microwave signal outputted by the first phase shift unit and the microwave signal outputted by the second phase shift unit is the preset value, so as to improve the isolation between the adjacent phase shift units, and achieve the arrangement of the phase shift units within a very small space while satisfying the requirement on antenna mirror feed, thereby to make full use of the space insider the antenna and reduce a volume of the antenna.

In some embodiments of the present disclosure, the forming the antenna unit includes: providing a first substrate; forming a radiation patch array at a side of the first substrate; and forming a first reference electrode at the other side of the first substrate.

The first substrate is at least one of a polytetrafluoroethylene fiberglass laminated substrate, a phenolic paper laminated substrate, a phenolic glass cloth laminated substrate, a quartz substrate and a glass substrate. A metal layer is formed on the substrate and patterned so as to form an array of the radiation patches.

In some embodiments of the present disclosure, the forming the phase shift unit includes: providing a second substrate and a third substrate; forming a coplanar waveguide transmission line on the third substrate; forming a loading electrode on the second substrate; aligning the third substrate with the second substrate to form a cell, the coplanar waveguide transmission line and the loading electrode being arranged between the third substrate and the second substrate; and filling a liquid crystal layer between the third substrate and the second substrate.

In some embodiments of the present disclosure, the antenna units is combined with the phase shift unit through bonding.

In some embodiments of the present disclosure, when attaching the antenna unit, the phase shift unit and the power division transmission unit, an alignment device is used to align the units with each other, and then the units are adhered to each other through an Optically Clear Adhesive (OCA) or any other UV-curable adhesive.

In the embodiments of the present disclosure, the order of the steps is not limited to the serial numbers thereof. For a person skilled in the art, any change in the order of the steps shall also fall within the scope of the present disclosure if without any creative effort.

It should be appreciated that, the above embodiments have been described in a progressive manner, and the same or similar contents in the embodiments have not been repeated, i.e., each embodiment has merely focused on the difference from the others. Especially, the method embodiments are substantially similar to the product embodiments, and thus have been described in a simple manner.

Unless otherwise defined, any technical or scientific term used herein shall have the common meaning understood by a person of ordinary skills. Such words as “first” and “second” used in the specification and claims are merely used to differentiate different components rather than to represent any order, number or importance. Similarly, such words as “one” or “one of” are merely used to represent the existence of at least one member, rather than to limit the number thereof. Such words as “include” or “including” intends to indicate that an element or object before the word contains an element or object or equivalents thereof listed after the word, without excluding any other element or object. Such words as “connect/connected to” or “couple/coupled to” may include electrical connection, direct or indirect, rather than to be limited to physical or mechanical connection. Such words as “on”, “under”, “left” and “right” are merely used to represent relative position relationship, and when an absolute position of the object is changed, the relative position relationship will be changed too.

It should be appreciated that, in the case that such an element as layer, film, region or substrate is arranged “on” or “under” another element, it may be directly arranged “on” or “under” the other element, or an intermediate element may be arranged therebetween.

In the above description, the features, structures, materials or characteristics may be combined in any embodiment or embodiments in an appropriate manner.

The above embodiments are for illustrative purposes only, but the present disclosure is not limited thereto. Obviously, a person skilled in the art may make further modifications and improvements without departing from the spirit of the present disclosure, and these modifications and improvements shall also fall within the scope of the present disclosure.

1. An antenna, comprising:
at least one group of antenna units;
at least one group of phase shift units, each group of phase shift units corresponding to a group of antenna units, each phase shift unit being configured to perform phase adjustment on a microwave signal; and
a power division transmission unit,
wherein each group of the antenna units comprises a first antenna unit and a second antenna unit, each group of the phase shift units comprises a first phase shift unit coupled to the first antenna unit and a second phase shift unit coupled to the second antenna unit, the power division transmission unit comprises at least one first power divider, each first power divider comprises a first end, a second end and a third end, the first end is coupled to the first phase shift unit, the second end is coupled to the second phase shift unit, and a phase difference between a microwave signal transmitted from the first end to the third end and a microwave signal transmitted from the second end to the third end is a preset value.

2. The antenna according to claim 1, wherein a line between the first end and the third end of each the first power divider is a first line, a line between the second end and the third end of each first power divider is a second line, and a difference between a length of the first line and a length of the second line is an odd multiple of a half wavelength of the microwave signal.

3. The antenna according to claim 2, further comprising a first resistor coupled to both the first line and the second line.

4. The antenna according to claim 1, wherein each antenna unit comprises: a first substrate; a first reference electrode arranged at a side of the first substrate and provided with a first via hole; and a radiation patch arranged at a side of the first substrate away from the first reference electrode, an orthogonal projection of the radiation patch onto the first substrate overlapping an orthogonal projection of the first via hole onto the first substrate at a first overlapping region.

5. The antenna according to claim 4, wherein each phase shift unit comprises: a second substrate and a third substrate arranged opposite to each other, the second substrate being arranged at a side of the first reference electrode away from the first substrate; a coplanar waveguide transmission line located at a side of the third substrate facing the second substrate; a loading electrode located at a side of the second substrate facing the third substrate; and a liquid crystal layer located between the second substrate and the third substrate, wherein the coplanar waveguide transmission line comprises a fourth end coupled to the first power divider and a fifth end coupled to the antenna unit.

6. The antenna according to claim 5, wherein the first overlapping region at least partially overlaps an orthogonal projection of a portion of the coplanar waveguide transmission line close to the fifth end onto the first substrate.

7. The antenna according to claim 5, wherein the first power divider is arranged at a same layer and made of a same material as the coplanar waveguide transmission line.

8. The antenna according to claim 5, wherein a first insulation layer is arranged between the loading electrode and the second substrate, and a second insulation layer is arranged at a side of the loading electrode away from the first insulation layer.

9. The antenna according to claim 8, wherein the coplanar waveguide transmission lines of all the phase shift units are electrically coupled to each other through a same signal line, and the loading electrodes of different phase shift units are insulated from each other.

10. The antenna according to claim 9, wherein the power division transmission unit further comprises at least one second power divider, each second power divider comprises a sixth end and a plurality of seventh ends, and each seventh end is coupled to the third end of one first power divider.

11. The antenna according to claim 10, wherein the power division transmission unit further comprises a second reference electrode arranged at a side of the third substrate away from the coplanar waveguide transmission line.

12. The antenna according to claim 11, wherein the first reference electrode is provided with at least one second via hole, the second reference electrode is provided with at least one third via hole, the second via holes correspond to the third via holes respectively, an orthogonal projection of each second via hole onto the third substrate overlaps an orthogonal projection of one third via hole onto the third substrate at a second overlapping region, and the second overlapping region at least partially overlaps an orthogonal projection of one third end onto the third substrate.

13. The antenna according to claim 12, wherein the power division transmission unit further comprises: a fourth substrate arranged between the second power divider and the second reference electrode; a fifth substrate arranged at a side of the second power divider away from the fourth substrate; and a third reference electrode arranged at a side of the fifth substrate away from the second power divider.

14. The antenna according to claim 13, wherein the third reference electrode is provided with at least one fourth via hole, the fourth via holes correspond to the third via holes respectively, an orthogonal projection of each fourth via hole onto the fifth substrate overlapping regions an orthogonal projection of one third via hole onto the fifth substrate at a third overlapping region, and the third overlapping region at least partially overlaps an orthogonal projection of one seventh end onto the fifth substrate.

15. The antenna according to claim 14, wherein the power division transmission unit further comprises: a sixth substrate arranged at a side of the third reference electrode away from the fifth substrate; and a back reflection layer arranged at a side of the sixth substrate away from the third reference electrode.

16. The antenna according to claim 15, wherein the power division transmission unit further comprises: a support frame arranged at a side of the back reflection layer away from the sixth substrate; and a waveguide arranged at a side of the support frame away from the sixth substrate.

17. The antenna according to claim 16, wherein the waveguide is coupled to the sixth end through a connector.

18. An antenna system, comprising the antenna according to claim 1.

19. A method for manufacturing an antenna, comprising:
forming at least one group of antenna units;
forming at least one group of phase shift units, each group of phase shift units corresponding to a group of antenna units, each phase shift unit being configured to perform phase adjustment on a microwave signal; and
forming a power division transmission unit,
wherein each group of the antenna units comprises a first antenna unit and a second antenna unit, each group of the phase shift units comprises a first phase shift unit coupled to the first antenna unit and a second phase shift unit coupled to the second antenna unit, the power division transmission unit comprises at least one first power divider, each first power divider comprises a first end, a second end and a third end, the first end is coupled to the first phase shift unit, the second end is coupled to the second phase shift unit, and a phase difference between a microwave signal transmitted from the first end to the third end and a microwave signal transmitted from the second end to the third end is a preset value,
wherein the forming the antenna unit comprises: providing a first substrate; forming a radiation patch array at a side of the first substrate; and forming a first reference electrode at the other side of the first substrate,
wherein the forming the phase shift unit comprises: providing a second substrate and a third substrate; forming a coplanar waveguide transmission line on the third substrate; forming a loading electrode on the second substrate; aligning the third substrate with the second substrate to form a cell, the coplanar waveguide transmission line and the loading electrode being arranged between the third substrate and the second substrate; and filling a liquid crystal layer between the third substrate and the second substrate,
wherein the antenna unit is combined with the phase shift unit through bonding.

20. A method for driving the antenna according to claim 1, comprising:
receiving, by each of a first antenna unit and a second antenna unit of each group of antenna units, a microwave signal;
performing, by a first phase shift unit, phase adjustment on the microwave signal received by the first antenna unit;
performing, by a second phase shift unit, phase adjustment on the microwave signal received by the second antenna unit; and
combining, by a first power divider, the microwave signal adjusted by the second phase shift unit and the microwave signal adjusted by the first phase shift unit into one signal, and/or,
dividing, by the first power divider, a microwave signal into two signals, and transmitting the signals to the first phase shift unit and the second phase shift unit respectively;
performing, by the first phase shift unit, phase adjustment on the microwave signal transmitted to the first phase shift unit, and performing, by the second phase shift unit, phase adjustment on the microwave signal transmitted to the second phase shift unit; and
transmitting, by first antenna unit, the microwave signal adjusted by the first phase shift unit, and transmitting, by second antenna unit, the microwave signal adjusted by the second phase shift unit.
